(19) United States
(12) Patent Application Publication
(10) Pub. No.: US 2007/0268875 A1
(43) Pub. Date: Nov. 22, 2007

(54) Role exchange method for Bluetooth system

(75) Inventors: Chung-I Lee, Hsinchu City (TW); Yao-Chun Yu, Hsinchu City (TW); Albert Chen, Hsinchu City (TW)

Correspondence Address: BIRCH STEWART KOLASCH & BIRCH, PO BOX 747, FALLS CHURCH, VA, 22040-0747, US

(73) Assignee: Integrated System Solution Corp.

(21) Appl. No.: 11/434,235

(22) Filed: May 16, 2006

(51) Int. Cl. H04Q 7/24; H04J 3/16

(52) U.S. Cl. 370/338; 370/346

(57) ABSTRACT

The present invention discloses a role exchange method for Bluetooth system. It comprises the steps of: a first slave asking role exchange and transmitting a FHS packet to a first master at a first time point t1; the first master exchanging as a second slave at the second time point t2; the first slave re-transmitting a plurality of FHS packet; and the first slave exchanging as a second master automatically. The role exchange method according to the present invention can solve the failure problem of role exchange procedure due to the noise in the conventional Bluetooth scheme.

### BACKGROUND OF THE INVENTION

1. Field of the invention

The present invention relates to a role exchange method, and more particularly to a role exchange method for Bluetooth wireless communication capable of avoiding noise interference effectively.

2. Description of the Related Art

Bluetooth is a technology used for wireless personal area network (WPAN), aiming at eliminating the need for cables and connectors among various devices. It can be applied to computers and peripherals, walkmen and earphones, etc. Bluetooth provides a robust and secure way to support date and audio wireless communication devices, which can be out of sight.

Referring to FIG. 1, it is a schematic illustrating a role exchange method for successfully transmitting a packet in the conventional Bluetooth scheme. At the first time point t1, the slave asks role exchange and transmits a FHS packet and then the master sends a confirm packet back. At the second time point t2, the master and slave exchange as a new slave and master, respectively. The new master still sends a poll packet. The new slave sent back an empty packet to finish the role exchange process after receiving the poll packet.

Bluetooth uses the 2.4 GHz ISM band which is the same as IEEE 802.11 WLAN. Mutual interference may occur and degrade the performances between the two wireless systems. Referring FIG. 2, it indicates the influence due to noise interference, ie, a schematic illustrating the failure problem of role exchange to transmit data in the conventional Bluetooth scheme. At the first time point t1, the slave asks role exchange and transmits a FHS packet and then the master sends a confirm packet back. The failure problem of receiving a confirm packet may exist due to noise or other effects. After transmitting a confirm packet to the slave, the master exchange as a new slave automatically at the second time point t2. However, the initial slave which did not receive the confirm packet thinks a FHS packet did not reach to the master. Therefore, the initial slave still transmits a FHS packet at the second time point t2. Since the initial master has exchanged as a new slave, they can not receive the packets from each other. This process keeps until the third time point t3 and is beyond the newconnectionTO. The new slave and master exchange back to the initial ones but the operation of the role exchange is fail. With respect to this kind of problems, the prevention mechanism is not described in the Bluetooth standard.

According the above problems, the related field needs a new role exchange to overcome the disadvantage of the prior art.

### BRIEF SUMMARY OF THE INVENTION

It is an object of the present invention to provide a role exchange method to solve the failure problem of role exchange procedure due to the outside noise and interference in the conventional Bluetooth scheme.

To achieve the above goals, the present invention provides a role exchange method for Bluetooth wireless communication, comprising the following steps of: a first slave asking role exchange and transmitting a FHS packet to a first master at a first time point t1; the first master exchanging as a second slave at the second time point t2; the first slave re-transmitting a plurality of FHS packet; and the first slave exchanging as a second master automatically at the second time point t3.

According to one aspect of the present invention, the role exchange method comprises the following steps of: the second master transmitting a poll packet; the second slave receiving it afterward, and transmitting an empty packet to the second master after the third time point t3.

According to another aspect of the present invention, the third time point t3 is between 0.625 ms and 20 ms and is less than a role exchange time of 20 ms.

According to another aspect of the present invention, the number of re-transmitting a FHS packet from the first slave is 2-6 times, and the optimized number is 3. If the first slave receives the confirm packet from the first master before re-transmitting the maximum number of FHS packets, the first slave can exchange as a second master.

### BRIEF DESCRIPTION OF THE DRAWINGS

All the objects, advantages, and novel features of the invention will become more apparent from the following detailed descriptions when taken in conjunction with the accompanying drawings.

FIG. 1 is a schematic illustrating a role exchange method for successfully transmitting a packet in the conventional Bluetooth scheme;

FIG. 2 is a schematic illustrating the failure problem of role exchange to transmit a packet in the conventional Bluetooth scheme; and

FIG. 3 is the process of role exchange to transmit a packet illustrating the embodiment according to the present invention.

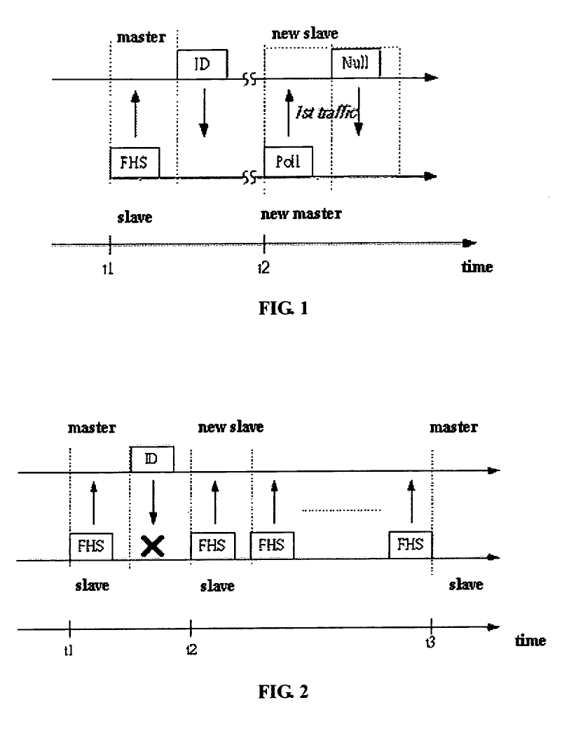

### DETAILED DESCRIPTION OF THE INVENTION

Although the invention has been explained in relation to several preferred embodiments, the accompanying drawings and the following detailed descriptions are the preferred embodiment of the present invention. It is to be understood that the following disclosed descriptions will be examples of present invention, and will not limit the present invention into the drawings and the special embodiment.

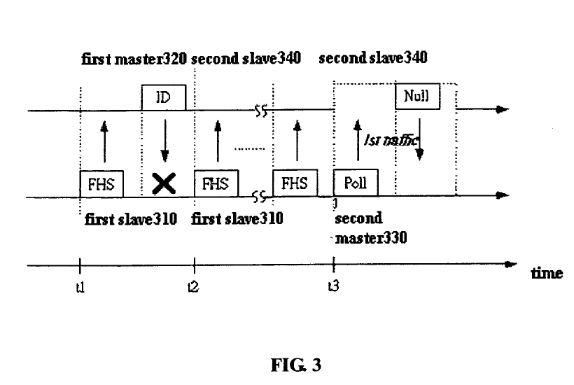

The present invention according to the Bluetooth standard presents a mechanism for avoiding the failure problem in the process of the role exchange due to noise or other effects. Now referring to the FIG. 3, it is the process of the role exchange illustrating the embodiment according to the present invention. The aspect of the mechanism is a method for re-transmitting packets and exchanging roles automatically, which can effectively solve the failure problem of role exchange procedure due to the FHS and the confirm packet affected in the conventional Bluetooth scheme.

By definition of Bluetooth system, all devices are on the same level and any Bluetooth device can be a Master or a Slave. The only rule is that the one first sending request of connecting is called the master and the other one is the slave, which is assigned during Piconet forming. It depends on the application that the master and the slave can exchange sometimes.

When the two Bluetooth devices are connected with each other, a physical channel is built in the baseband, in which a Time Division Duplex (TDD) scheme is used for transmitting signals between the master and the slave. The master sends out the data during even time slot and the slave must listen for the master before it may send out the information.

The role exchange procedure starts at a first time point t1. A first slave 310 asks role exchange and transmits a FHS packet to a first master 320. Then, the first master 320 sends a confirm packet back. Even though the first slave 310 did not receive the confirm packet due to noise or other factors, the first master 320 has exchanged as a second slave 340 at the second time point t2. The first slave 310, which did not receive the confirm packet from the first master 320 does not know whether the first master 320 received a FHS packet or not and transmits a plurality of FHS packet. The first slave 310 exchanges as a second master 330 automatically at the second time point t3, which can avoid the failure of role exchange procedure.

After the time point t3, the master and slave exchange as a new slave and master, respectively and then the second master 330 sends a poll packet. After the second slave 340 receives the poll packet, an empty packet will be sent back to the second master 330 to finish the role exchange process.

The first slave 310 asks role exchange to be a master, transmits a FHS packet to a first master 320, and comprises the following steps of: the first master 320 transmitting a confirm packet to the first slave 310.

In general, the first time point t1 is less than t2, and the second time point t2 is less than the third time point t3. The third time point t3 can be set between 0.625 ms-20 ms, and is preferred a multiple of 0.625 ms. However it is noted that the third time point t3 needs to be less than a role exchange time, 20 ms.

The number of re-transmitting a FHS packet from the first slave 310 is 2-6 times, and the optimized number is 3. If the first slave 310 receives the confirm packet from the first master 320 before re-transmitting the maximum number of FHS packets, the first slave 310 can exchange as the second master 330.

The packet transmission does not occupy the full time slot of 625 μs in length, ie, 1600 slots/sec. Bluetooth adopts the mechanism for frequency hopping, which hops from one time slot to another channel and divides 2.45 GHz band into 79 channels of 1 MHz to transmit data.

The master can only send at even-numbered time slot and the slave can only send at odd-numbered time slot. Packets transmitted by the master may span over one, three, or up to five time slots.

The FHS including three parts of access code, header, and payload is the same as packets at other intervals ( wherein synchronous connect orientation, SCO, and asynchronous connect link, ACL). A confirm packet consists of access code and is used during the pre-connection. A confirm packet is a powerful information machine since it carries information of access codes indicating where to go or to come from. A null packet consists of access code and header and does not need to receive any feedback message. A poll packet has the same structure as the null packet but it requires a response.

In summary, the present invention provides a role exchange method for Bluetooth wireless communication, which avoids the failure problem of role exchange as connecting with Bluetooth devices and reinforces the weakness in the Bluetooth scheme by using the mechanism for re-transmitting packets and exchanging role. Because of sufficient stability of connecting and being connected, the users can feel satisfied.

Although the invention has been explained in relation to its preferred embodiment, it is not used to limit the invention. It is to be understood that many other possible modifications and variations can be made by those skilled in the art without departing from the spirit and scope of the invention as hereinafter claimed.

What is claimed is:

1. A role exchange method for Bluetooth wireless communication comprising the following steps of:
a first slave asking role exchange and transmitting a FHS packet to a first master at a first time point t1;
the first master exchanging as a second slave at the second time point t2;
the first slave re-transmitting a plurality of FHS packet if the confirm packet is not received; and
the first slave exchanging as a second master automatically at the third time point t3.

2. The role exchange method for Bluetooth wireless communication of claim 1, wherein at the first time point t1 comprising the further steps of:
a first slave asking role exchange and transmitting a FHS packet to a first master at a first time point t1; and the first master sending a confirm packet to the first slave.

3. The role exchange method for Bluetooth wireless communication of claim 1, comprising the further steps of:
the second master transmitting a poll packet after the third time point t3; and
the second slave receiving the poll packet afterward, and transmitting an empty packet to the second master.

4. The role exchange method for Bluetooth wireless communication of claim 1, wherein the third time point t3 is between 0.625 ms.20 ms.

5. The role exchange method for Bluetooth wireless communication of claim 4, wherein the third time point t3 is a multiple of 625 ms.

6. The role exchange method for Bluetooth wireless communication of claim 1, wherein the third time point t3 is less than a role exchange time.

7. The role exchange method for Bluetooth wireless communication of claim 1, wherein the number of re-transmitting a FHS packet from the first slave is 2-6 times.

8. The role exchange method for Bluetooth wireless communication of claim 1, wherein the first slave can exchange as the second master on condition that the first slave receives the confirm packet from the first master before re-transmitting the maximum number of FHS packets.
